(19) United States
(12) Patent Application Publication
(10) Pub. No.: US 2008/0079801 A1
(43) Pub. Date: Apr. 3, 2008

(54) Video conference system and video conference method

(75) Inventor: Michiaki Eri, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/902,853

(22) Filed: Sep. 26, 2007

(30) Foreign Application Priority Data
Sep. 29, 2006 (JP) 2006-269970

(51) Int. Cl. H04N 7/15; G06F 15/16

(52) U.S. Cl. 348/14.09; 709/203; 348/E07.083

(57) ABSTRACT

According to one embodiment, a video conference system comprises a server and a plurality of client terminals. Each of the client terminals includes a selection unit configured to select the layout information stored in the storage unit of the server, a display unit which displays the synthesized image received from the server, a change unit configured to change a layout of the synthesized image displayed on the display unit, an image inputting and transmitting unit which inputs an image and transmits the image to the server, and a transmission unit configured to, if the layout information is selected by the selection unit and if the layout information is changed by the change unit, transmit the layout information to the server.

### CROSS-REFERENCE TO RELATED APPLICATIONS

This application is based upon and claims the benefit of priority from Japanese Patent Application No. 2006-269970, filed Sep. 29, 2006, the entire contents of which are incorporated herein by reference.

### BACKGROUND

1. Field

One embodiment of the invention relates to the present invention relates to a video conference system and, more particularly, to a video conference system and a video conference method capable of sending and receiving images via a server.

2. Description of the Related Art

As for the technology of a video conference system capable of sending and receiving images via a server, user's images displayed on client terminals of the video conference system can be displayed or iconized as disclosed in, for example, JP-A No. 8-294100 (KOKAI) (cf. JP-A No. 8-294100 (KOKAI)).

According to this technology, however, a display format displayed on a client terminal cannot be stored on the server side. In addition, a predetermined template cannot be stored on the server side or cannot be used on the client terminal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary illustration showing a configuration of a video conference system according to an embodiment of the present invention;

FIG. 2 is an exemplary block diagram showing main components of a client terminal according to the embodiment of the present invention;

FIG. 3 is an exemplary flowchart showing a video conference method to which the video conference system according to an embodiment of the present invention is applied;

FIG. 4 is an exemplary table showing detailed data of position information according to the embodiment;

FIG. 5 is an exemplary illustration showing a screen display of client terminal A according to the embodiment;

FIG. 6 is an exemplary illustration showing a screen display of client terminal B according to the embodiment;

FIG. 7 is an exemplary illustration showing a screen display of client terminal C according to the embodiment;

FIG. 8 is an exemplary illustration showing a screen display of client terminal D according to the embodiment;

FIG. 9 is an exemplary illustration showing a screen display upon clicking an image of client terminal A according to the embodiment;

FIG. 10 is an exemplary illustration showing a state in which a size of the image of client terminal A is changed according to the embodiment; and

FIG. 11 is an exemplary table showing detailed data of position information after change of the size according to the embodiment.

### DETAILED DESCRIPTION

Various embodiments according to the invention will be described hereinafter with reference to the accompanying drawings. In general, according to one embodiment of the invention, a video conference system, comprising a server and a plurality of client terminals transmitting input images to the server, the server includes: an storage unit which stores an image and layout information transmitted from each of the plurality of client terminals; and a synthesized image transmission unit configured to arrange the images transmitted from the plurality of client terminals in accordance with the layout information stored in the storage unit, as a synthesized image, and transmitting the synthesized image in response to each of the client terminals transmitting the layout information, each of the client terminals comprising: a selection unit configured to select the layout information stored in the storage unit of the server; a display unit which displays the synthesized image received from the server; a change unit configured to change a layout of the synthesized image displayed on the display unit; an image inputting and transmitting unit which inputs an image and transmits the image to the server; and a transmission unit configured to, if the layout information is selected by the selection unit and if the layout information is changed by the change unit, transmit the layout information to the server.

An embodiment of the present invention will be described below with reference to the accompanying drawings.

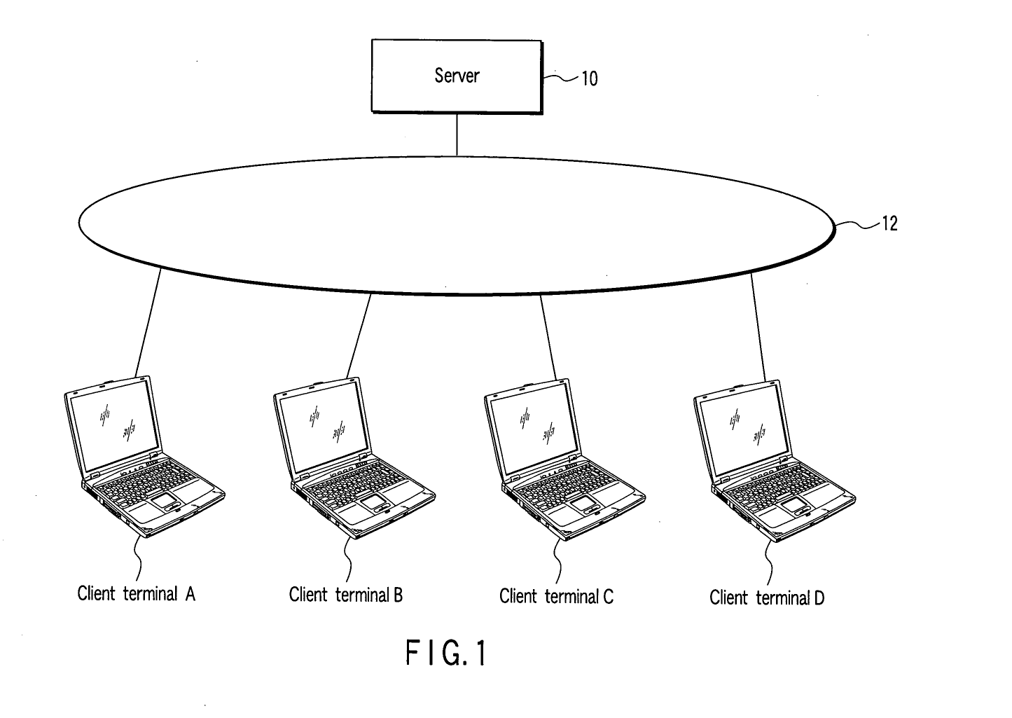

FIG. 1 is an illustration showing a video conference system according to an embodiment of the present invention. The video conference system is constituted by a plurality of client terminals.

The video conference system is constituted by a server 10, a network 12 such as the Internet, and a plurality of client terminals A to D as shown in FIG. 1. All of image data items input from each of the client terminals A to D are transmitted to the server 10. The server 10 merges and transmits all of the received image data to each of the client terminals A to D as one image data (merged image) in which each of the image data items is arranged.

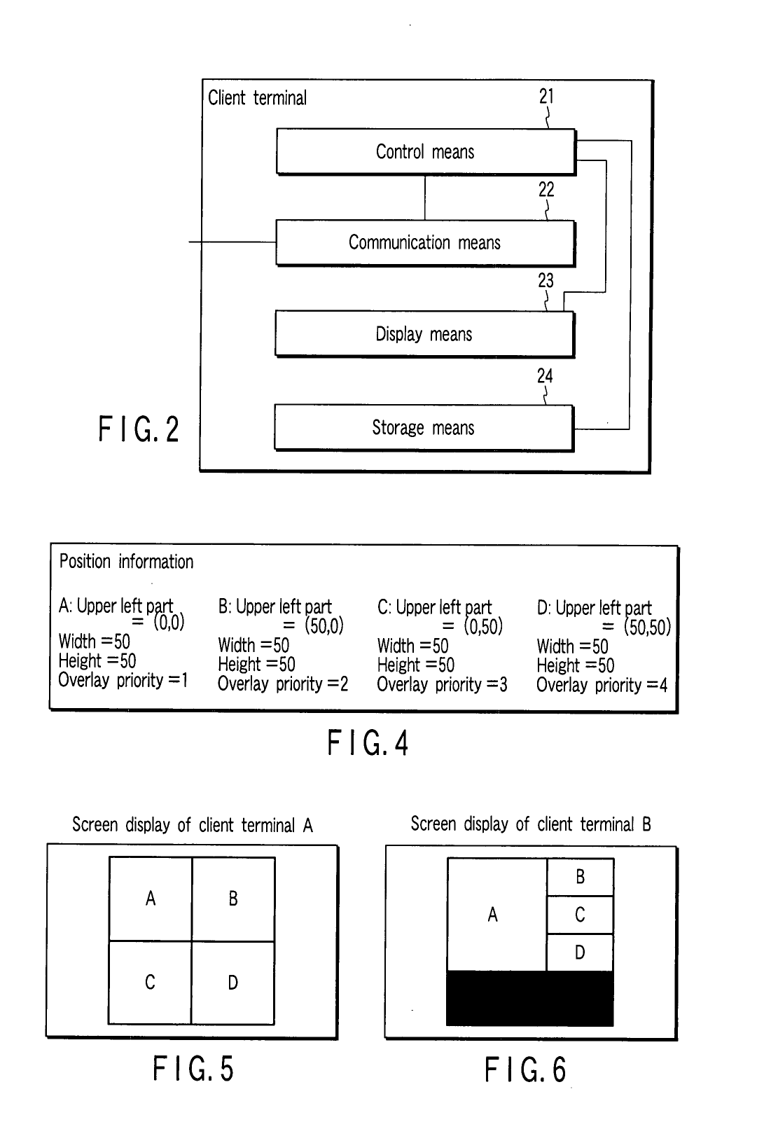

As the client terminals, for example, personal computers are employed and constituted as shown in FIG. 2. Each of the client terminals comprises control means 21, communication means 22, a display unit 23 and a storage unit 24.

The control means 21 comprises an image input device such as a Web camera or the like configured to input images of the video conference system, transmits the images input from the image input device to the communication means 22, receives images transmitted from the server 10 via the communication means 22 and displays the images on the display unit 23. The communication means 22 transmits and receives layout information to determine a position of layout to display image data and images via the network 12. The display unit 23 displays the received image data. The display unit 23 also displays a transparent layer for changing the position of the image data (hereinafter also called transparent frame). The transparent layer is a plurality of layer data items superposed with the same size as the images arranged in the received image data (synthetic image where image data items received from a plurality of client terminals are arranged). By changing the size of the transparent layer, layout information of the changed layout is transmitted to the server. The storage unit 24 stores the received synthetic image and the downloaded layout information.

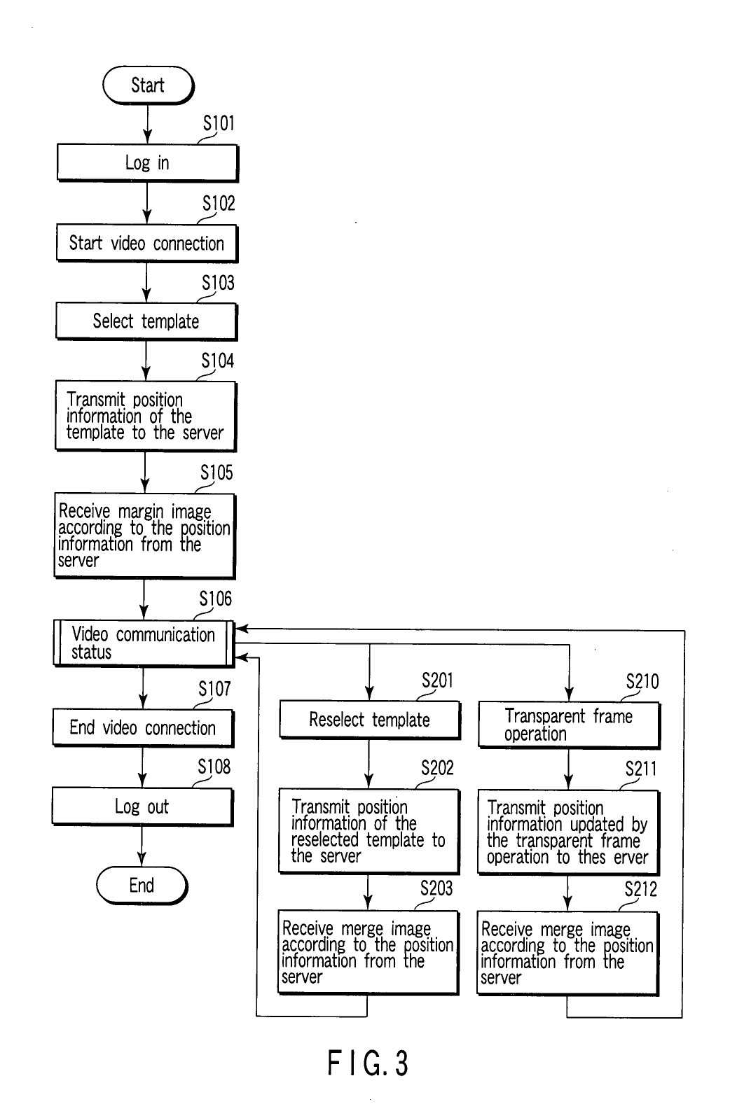

Next, a video conference method to which the video conference system of the present invention is applied is described with reference to a flowchart of FIG. 3. In the embodiment, four client terminals A to D are employed, but the number of the client terminals may be varied and is not limited to four.

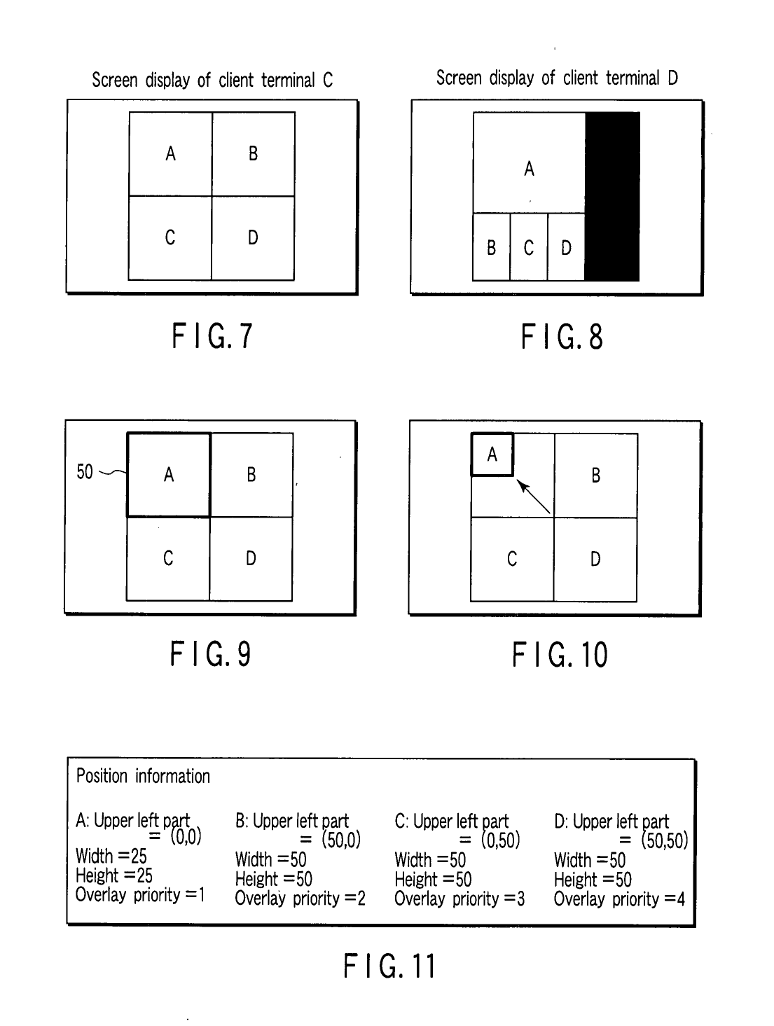

First, the client terminals access the server 10 via the network 12 to log in (step S101). When the login of the client terminals is completed, templates stored in the server are entirely downloaded as position information and stored in the client terminals. Next, the client terminals start video connection (step S102). One of the downloaded templates is selected upon the video connection (step S103) and transmitted to the server as the position information (step S104). At the client terminals, images based on the selected layout information are received from the server 10 (step S105), and displayed (step S106). The layout information as referred to an upper left part of each of images (images of client terminals A to D) is “image of client terminal A: upper left part=(0, 0), width=50, height=50 and overlay priority=1, image of client terminal B: upper left part=(50, 0), width=50, height=50 and overlay priority=2, image of client terminal C: upper left=(0, 50), width=50, height=50 and overlay priority=3”, and image of client terminal D: upper left=(50, 50), width=50, height=50 and overlay priority=4” as shown in, for example, FIG. 4. On the basis of the layout information, the images of the client terminals A to D are displayed. The images transmitted from four client terminals A to D are displayed in four divided fields of a screen of the client terminal A, respectively, as shown in FIG. 5. On a screen of the client terminal B, the images transmitted from the client terminals A to D are displayed such that the image of the client terminal A is displayed largely and the images of the client terminals C to D are displayed in three divided fields of the remaining area of the screen, respectively, as shown in FIG. 6. On a screen of the client terminal C, the images transmitted from four client terminals A to D are displayed in four divided fields, as shown in FIG. 7. On a screen of the client terminal D, the images transmitted from the client terminals A to D are displayed such that the image of the client terminal A is displayed largely and the images of the client terminals C to D are displayed in three divided fields of the remaining area of the screen, respectively, as shown in FIG. 8. The overlay priority is the information to determine which of the superposed images should be displayed at an upper position. The priority of the clicked image is highest. For example, if an image 50 of the client terminal A is clicked as shown in FIG. 9, the overlay priority of the image 50 of the client terminal A becomes 1 irrespective of the preset overlay priority. The other images are reset to have the overlay priority of 2, 3, 4 in order of higher overlay priority.

In the flowchart of FIG. 3, the client terminals become in a status of video communication with the server 10 (step S106). If the template is re-selected by the client terminals in the video communication status, the operation shifts to step S201, the position information of the re-selected template is transmitted to the server 10 (step 202), and a merge image corresponding to the transmitted position information is received from the server 10 (step S203). If an operation of a transparent frame is executed in the video communication status, the client terminals shift to step S210 and transmit the position information updated by the operation of the transparent frame to the server 10 (step S211). The client terminals receive the merge image corresponding to the transmitted position information from the server 10 (step S212). When the client terminals receive an end command, the client terminals end the operation (step S107) and log out (step S108).

Next, an operation of the transparent frame is described. The control means 21 in each of the client terminals starts the process when the operation of the transparent frame is executed. For example, if the image 50 of the client terminal A is clicked as shown in FIG. 9, the image 50 is surrounded by a line (broad line). This line represents the transparent frame. If it is discriminated by the control means 21 in each of the client terminals that the operation of the transparent frame has been executed, the control means 21 transmits the position information to the server 10. For example, if a mouse is placed on the line and then moved while clicking, the size of the image 50 of the client terminal A can be changed as shown in FIG. 10. The change of the transparent frame is transmitted to the server 10 as a change of the position information as shown in FIG. 11. For example, the changed position information is “image of client terminal A: upper left part=(0, 0), width=25, height=25 and overlay priority=1, image of client terminal B: upper left part=(50, 0), width=50, height=50 and overlay priority=2, image of client terminal C: upper left=(0, 50), width=50, height=50 and overlay priority=3”, and image of client terminal D: upper left=(50, 50), width=50, height=50 and overlay priority=4”. The position information on the image of the client terminal A is changed as compared with the position information of FIG. 4.

Thus, the position information can be easily changed intuitively by using the transparent frame, and the change can be transmitted to the server.

Next, the control means 21 in each of the client terminals receives the merge image (synthesized image) position information from the server 10 via the network 12 and the communication means 22, and displays the information by the display unit 23 (for example, FIG. 10). If the displayed layout information is stored in the server as a template by the control means 21 in each of the client terminals, the layout information (template information) is transmitted to the server. The server 10 stores the received template information such that the template information can also be employed by the other client terminals. When the client terminal receives an end command, the operation is ended.

The template information (layout information) stored in the server 10 is entirely downloaded to the client terminals when the client terminals log in the server 10. Besides the layout selected at the login, the layout can be changed at an arbitrary timing at the client terminals (steps S201 to S203 in FIG. 3). When the layout is selected at the login, the screens shown in FIG. 5 to FIG. 8 are displayed and the layout can be intuitively understood.

As described above, the display formats displayed on the client terminals can be stored in the server and can be shared by all the client terminals employing the video conference system. In addition, the position information can be easily changed by using the transparent frame and the change can be transmitted to the server.

In the above-described embodiment, the position information is transmitted to the server before the reception of the merge image, but may be transmitted to the server after the reception of the merge image.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video conference system, comprising a server and a plurality of client terminals transmitting input images to the server,
the server comprising:
an storage unit which stores an image and layout information transmitted from each of the plurality of client terminals; and
a synthesized image transmission unit configured to arrange the images transmitted from the plurality of client terminals in accordance with the layout information stored in the storage unit, as a synthesized image, and transmitting the synthesized image in response to each of the client terminals transmitting the layout information,
each of the client terminals comprising:
a selection unit configured to select the layout information stored in the storage unit of the server;
a display unit which displays the synthesized image received from the server;
a change unit configured to change a layout of the synthesized image displayed on the display unit;
an image inputting and transmitting unit which inputs an image and transmits the image to the server; and
a transmission unit configured to, if the layout information is selected by the selection unit and if the layout information is changed by the change unit, transmit the layout information to the server.

2. The system according to claim 1, wherein the change unit are a plurality of transparent layers each having a same size as each of the images arranged in the synthesized image and being superposed, and the layout information is transmitted to the server after the change of the layout, by changing the sizes of the transparent layers.

3. The system according to claim 2, wherein when one of the transparent layers is selected, the transparent layer is visibly displayed so as to be surrounded by a line.

4. The system according to claim 1, wherein the selection unit in each of the client terminals downloads the layout information stored in the storage unit of the server and arbitrarily selects the layout in accordance with the downloaded layout information.

5. The system according to claim 1, wherein the layout information stored in the storage unit of the server is shared and used by the plurality of client terminals.

6. A video conference method, comprising a server and a plurality of client terminals transmitting input images to the server,
the method further comprising:
urging the client terminals to select layout information stored in a storage unit of the server and download the layout information;
urging the client terminals to transmit the input images to the server;
urging the server to store the images and selected layout information transmitted from the plurality of client terminals, in the storage unit;
urging the server to arrange the images transmitted from the plurality of client terminals in accordance with the layout information stored in the storage unit, as a synthesized image, and transmit the synthesized image in response to each of the client terminals transmitting the layout information;
urging each of the client terminals to display the synthesized image received from the server; and
if a layout of the displayed synthesized image is changed, urging each of the client terminals to transmit the layout information to the server.

7. The method according to claim 6, wherein the change indicates a plurality of transparent layers each having a same size as each of the images arranged in the synthesized image and being superposed, and the layout information is transmitted to the server after the change of the layout, by changing the sizes of the transparent layers.

8. The method according to claim 7, wherein when one of the transparent layers is selected, the transparent layer is visibly displayed so as to be surrounded by a line.

9. The method according to claim 6, wherein the selection downloads the layout information stored in the storage unit of the server and arbitrarily selects the layout in accordance with the downloaded layout information.

10. The method according to claim 6, wherein the layout information stored in the storage unit of the server is shared and used by the plurality of client terminals.
